(19) United States
(12) Patent Application Publication
(10) Pub. No.: US 2010/0023367 A1
(43) Pub. Date: Jan. 28, 2010

(54) METHOD AND SYSTEM FOR MANAGING WORKSHEET PRIORITY, AND METHOD AND SYSTEM FOR PROCESSING WORKSHEET

(75) Inventor: Pingfan Xie, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/574,041

(22) Filed: Oct. 6, 2009

Related U.S. Application Data
(63) Continuation of application No. PCT/CN2008/070616, filed on Mar. 28, 2008.

(30) Foreign Application Priority Data
Apr. 9, 2007 (CN) 200710073823.7

(51) Int. Cl. G06Q 10/00; G06F 17/30

(52) U.S. Cl. 705/8; 707/3; 705/7; 707/E17.014; 707/E17.044

(57) ABSTRACT

A method for managing worksheet priority is disclosed according to embodiments of the present invention. The method includes steps of: obtaining worksheet information; calculating a worksheet priority based on a Service Level Agreement; and updating the worksheet information based on the worksheet priority. Also, a system for managing worksheet priority, a method and a system for processing worksheet are further provided according to the embodiments of the present invention. The priority of the worksheet is calculated based on the Service Level Agreement according to the embodiments of the present invention. Thus, it ensures that resources in an enterprise are allocated based on the Service Level Agreement, and a worksheet with a higher service level is processed first. As such, it ensures that internal resources in the enterprise are allocated based on the Service Level Agreement. Meanwhile, it may not occur that the user with a low Service Level Agreement is always given no opportunity of the service.

### CROSS REFERENCE

The present application is a continuation of International Patent Application No. PCT/CN2008/070616, filed on Mar. 28, 2008, which claims priority to Chinese Patent Application No. 200710073823.7, filed on Apr. 9, 2007, both of which are hereby incorporated by reference in their entireties

### FIELD OF THE INVENTION

Embodiments of the present invention relates to worksheet procedure management technique, more specifically, to a method and system for managing worksheet priority and a method and system for processing worksheet.

### BACKGROUND

In telecommunication, a priority for each worksheet in a workflow queue is required to be set during a procedure for processing workflow services, to process an urgent worksheet first. A worksheet is provided with a priority attribution, and thus a worksheet service processing operator or a worksheet service processing system may firstly process the worksheet with a higher priority by identifying the worksheet priority attribution.

According to a conventional method for managing worksheet priority, a worksheet priority administrator sets a priority for each worksheet. At each work station, worksheets are sorted based on the worksheet priorities to ensure that the worksheet with a high priority is arranged in a position for a prior processing. According to a sequence of worksheet priority, the worksheets are processed in a sequence from a high priority to a low priority.

During the implementation of the present invention, the inventors find out that there exist problems in conventional art as follows: the worksheet priority can only be a fixed value according to the above method for processing worksheet, while the worksheet priority may vary with time or other factors in a telecommunication operation and support system. For instance, an ordinary complaint may have less impact and low priority. However, a user will probably submit an ordinary complaint without being processed for even a week to a senior department. Therefore, the priority of the ordinary complaint sheet without being processed for a week must be raised up.

Furthermore, the worksheet priority is set as a fixed value according to the conventional method for managing worksheet priority. Thus, a worksheet with a low priority may not be processed during quite a long time as long as worksheets with a high priority enter in succession.

Since the priority is set by the administrator, this is subjective and random in some degree. As such, man-made determination faults may easily occur, which result in an inappropriate setting for worksheet priorities. Moreover, the priority set manually is a fixed value that can not be adjusted dynamically with time.

### SUMMARY

According to embodiments of the present invention, a method and system for managing worksheet priority, a method and system for processing worksheet during a worksheet procedure are provided in order to dynamically adjust worksheet priorities in workflows.

A method for managing worksheet priority is provided according to an embodiment of the present invention. The method includes steps of: obtaining worksheet information; calculating a worksheet priority based on a Service Level Agreement; and updating the worksheet information based on the worksheet priority.

A method for processing worksheet is further provided according to an embodiment of the present invention. The method includes steps of: receiving a pending worksheet, and obtaining worksheet information on the pending worksheet; calculating a worksheet priority based on a Service Level Agreement; updating the worksheet information based on the worksheet priority, and processing the worksheet based on a priority sequence of the worksheet.

A system for managing worksheet priority is further provided according to an embodiment of the present invention. The system includes: a worksheet information obtaining module, an agreement processing module, a calculating unit and an updating unit, wherein, the worksheet information obtaining module is configured to obtain priority information and client information on the worksheet; the agreement processing module is configured to provide a Service Level Agreement based on client information obtained by the worksheet information obtaining module; the calculating unit is configured to calculate a priority of the worksheet based on the priority information obtained by the worksheet information obtaining module and the Service Level Agreement provided by the agreement processing module; and the updating unit is configured to update the priority information on the worksheet based on the priority calculated by the calculating unit.

A system for processing worksheet is further provided according to an embodiment of the present invention. The system includes: a worksheet priority management system, configured to manage a priority of the worksheet; a workflow engine, configured to coordinate and schedule a turnover for the worksheet, and receive the worksheet, wherein the worksheet is arranged in a priority sequence in the workflow engine according to the worksheet priority management system; a pending worksheet obtaining subsystem, configured to obtain a worksheet with a currently higher priority in the workflow engine; and a worksheet processing system, configured to process the worksheet obtained by the pending worksheet obtaining subsystem based on the worksheet priority.

Compared with the conventional art, the priority of the worksheet is calculated based on the SLA according to the embodiments of the present invention, so that the worksheet with a lower original priority may have an opportunity of obtaining a reallocated priority because of not being processed for quite a long time. Thus, it may ensure that internal resources in an enterprise may be allocated based on an SLA. Meanwhile, it may not occur that the user with a low SLA is always given no opportunity of the service. As a result, priorities for worksheets are appropriately allocated. Furthermore, worksheet priorities are calculated based on the SLA and are updated to thereby prevent the man-made subjective and random performance of the administrator.

### BRIEF DESCRIPTION OF THE DRAWINGS

FIG. 1 illustrates a block diagram of a worksheet working system according to a preferred embodiment of the present invention;

FIG. 2 illustrates a block diagram of a system for managing worksheet priority according to a preferred embodiment of the present invention;

FIG. 3 illustrates a flowchart of a method for managing worksheet priority according to a preferred embodiment of the present invention; and

FIG. 4 illustrates a flowchart of processing worksheet according to a preferred embodiment of the present invention.

### DETAILED DESCRIPTION

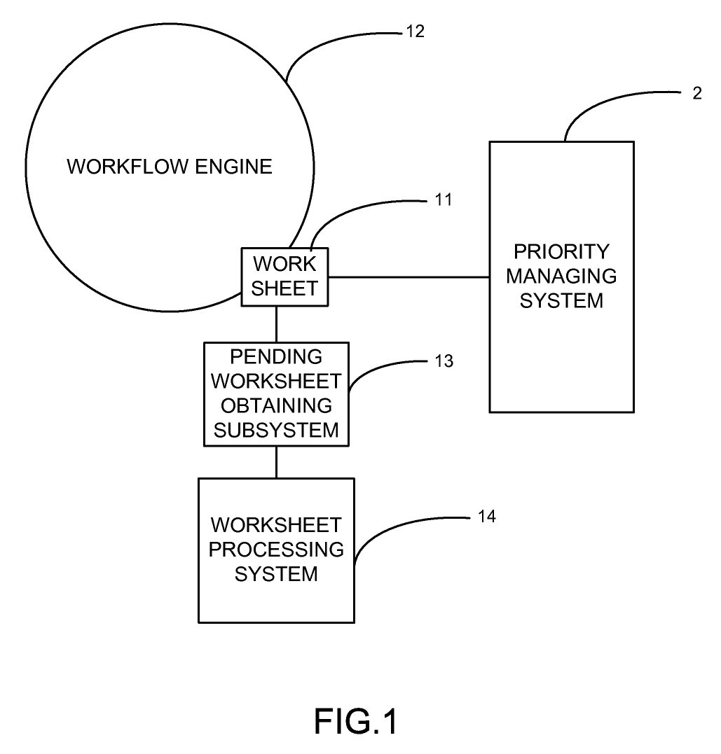

Referring to FIG. 1, FIG. 1 is a block diagram of a worksheet working system according to a preferred embodiment. A priority managing system 2 connected to a worksheet 11 is configured to manage a priority of the worksheet 11. Priority information and client information may be set for the worksheet 11, wherein the priority information and the client information is collectively called worksheet information. The priority information includes a priority level and a priority validity period. The client information includes a client level, a client brand and a client location, etc. The client information may be stored in the worksheet 11. Or, of course, it may only store a client information index in the worksheet 11, while specific contents of the client information may be stored in another storing unit other than the worksheet 11. The worksheet 11 is sorted in a workflow engine 12 according to a priority sequence managed by the priority managing system 2. The workflow engine 12 is configured to coordinate and schedule a turnover for the worksheet 11, and to receive the worksheet 11. A pending worksheet obtaining subsystem 13 is configured to obtain a worksheet with a currently higher priority in the workflow engine 12. A worksheet processing system 14 processes the worksheet obtained by the pending worksheet obtaining subsystem 13.

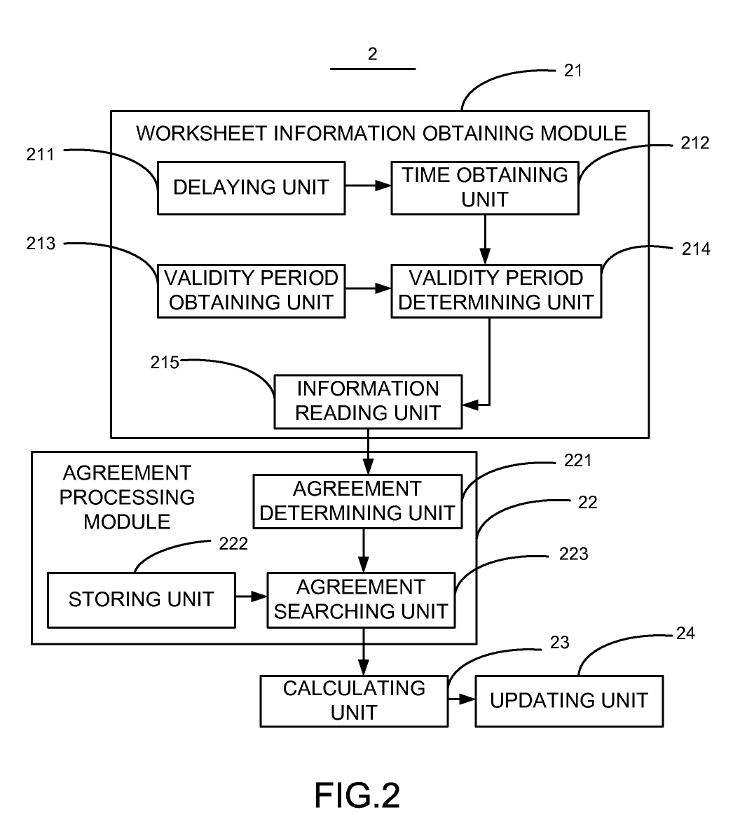

Referring to FIG. 2, FIG. 2 is a block diagram of a system for managing worksheet priority according to a preferred embodiment. A worksheet priority managing system 2 includes: a worksheet information obtaining module 21, an agreement processing module 22, a calculating unit 23 and an updating unit 24.

The worksheet information obtaining module 21 is configured to obtain the priority information and the client information on the worksheet 11. The agreement processing module 22 provides a Service Level Agreement (SLA) based on the client information obtained by the worksheet information obtaining module 21. The SLA is an agreement text, which specifies rights (service levels) and obligations between clients and an operator, and may include one or more articles. The calculating unit 23 calculates the priority of the worksheet 11 based on the priority information obtained by the worksheet information obtaining module 21 and the SLA provided by the agreement processing module 22. The updating unit 24 updates the priority information on the worksheet 11 based on the priority calculated by the calculating unit 23.

The worksheet information obtaining module 21 further includes: a delaying unit 211, a time obtaining unit 212, a validity period obtaining unit 213, a validity period determining unit 214 and an information reading unit 215. The delaying unit 211 is configured for timing, in order to generate a trigger signal after a fixed time, e.g., the delay time may be set to 1 minute in the present embodiment. The time obtaining unit 212 obtains current time based on the trigger signal provided by the delaying unit 211. The validity period obtaining unit 213 obtains a validity period of the worksheet 11. The validity determining unit 214 determines whether the validity period of the worksheet 11 obtained by the validity obtaining unit 213 is less than the current time obtained by the time obtaining unit 212, i.e., whether the current time obtained by the time obtaining unit 212 has arrived at the validity period of the worksheet 11 obtained by the validity obtaining unit 213. If the validity period of the worksheet is less than the current time, the calculating unit 23 is notified to calculate the worksheet priority based on the SLA. If the validity period of the worksheet is no less than the current time, the procedure is completed. The information reading unit 215 is configured to read the original priority information and client information on the worksheet 11.

The agreement processing module 22 further includes: an agreement determining unit 221, a storing unit 222 and an agreement searching unit 223. The agreement determining unit 221 determines whether the worksheet 11 has signed the SLA based on the client information on the worksheet 11. The storing unit 222 is configured to store the SLA articles. The agreement searching unit 223 is configured to search for the SLA articles stored in the storing unit 222 based on a determination result conducted by the agreement determining unit 221.

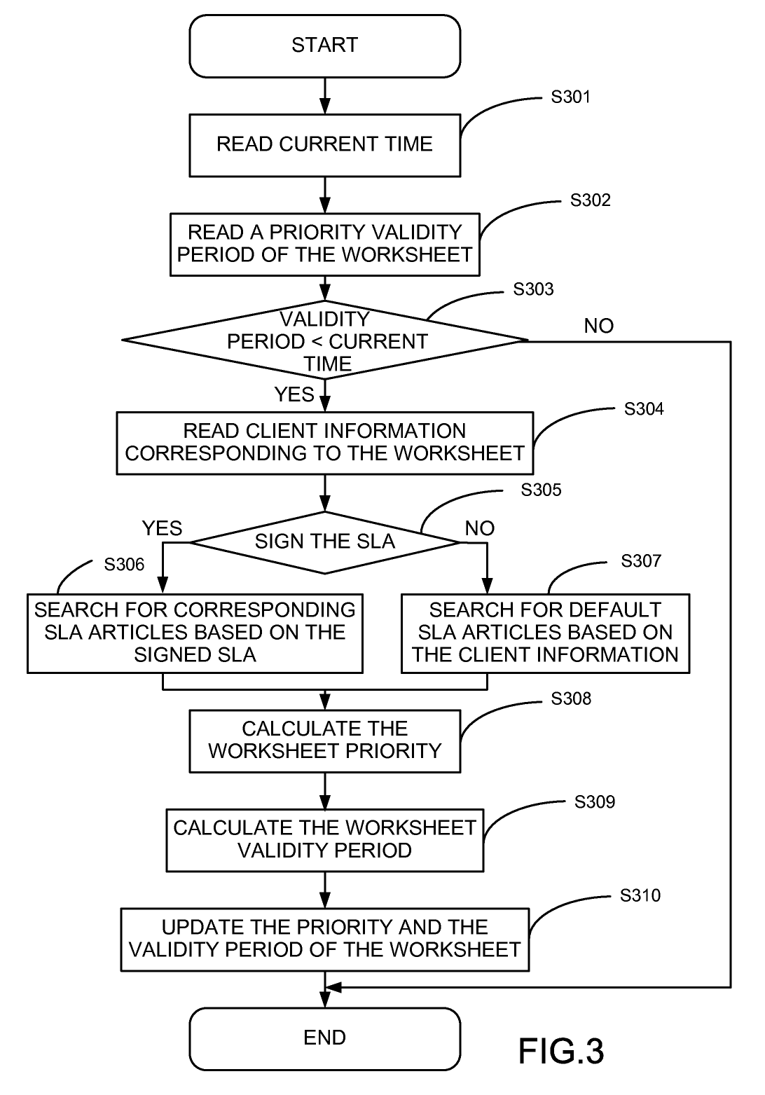

Referring to FIG. 2 and FIG. 3 together, FIG. 3 is a flowchart of a method for managing worksheet priority according to a preferred embodiment. The description below will be made taking an example of a procedure for processing a worksheet 11. A method for managing worksheet priority includes steps as follows.

Step S301: Current time is read. According to the present preferred embodiment, a delay may be performed by the delaying unit 211 before the current time is read. The delay may be performed by providing a trigger signal after a fixed time.

Step S302: A priority validity period of the worksheet 11 is read. The priority validity period of the worksheet 11 may be a time value of a worksheet 11 life span from beginning to end, or up to a specific valid time value. The validity period can be a fixed value, or can be a value related to at least one of the following parameters: the service type, the client information, and the SLA information.

Step S303: It is determined whether the validity period of the worksheet 11 is less than the current time. If the validity period of the worksheet 11 is less than the current time, step S304 is performed; if the validity period of the worksheet 11 is no less than the current time, the procedure is completed.

Step S304: The client information on the worksheet 11 is obtained. The client information can be stored in the worksheet 11. Or, of course, it may only store a client information index in the worksheet 11, while specific contents of the client information may be stored in another storing unit 222 other than the worksheet 11.

Step S305: It is determined whether a client corresponding to the worksheet 11 has signed the SLA based on the client information on the worksheet 11. If the client corresponding to the worksheet 11 has signed the SLA, step S306 is performed; if the client corresponding to the worksheet 11 has not signed the SLA, step S307 is performed.

Step S306: The SLA articles corresponding to the worksheet 11 are searched based on the client information on the worksheet 11. Step S308 is performed after step S306.

Step S307: A default SLA for such type of the client is obtained by a combination match based on the client level, client brand, location which are included in the client information on the worksheet 11, and the service type which is included in the worksheet 11, to thereby search for the required SLA articles.

Step S308: The priority of the worksheet 11 is calculated. The calculation is based on each SLA article and the priority information and client information included in the worksheet 11. At this step, the priority of the worksheet 11 is consisted of three parts, an worksheet inherent attribute part, an SLA compensation part, and a time accumulation part. The inherent attribute part of the worksheet 11 includes the client information and the service type. The inherent attribute part of the worksheet and the time accumulation part therein relate to the worksheet 11, which are accumulated only once. The SLA compensation part may include one or more articles according to the SLA articles. During calculation, calculation indicators related to the required SLA articles are accumulated for processing.

The calculation method for the inherent attribute part of the worksheet 11 is to take the inherent attribute of the worksheet 11, the service type of the worksheet 11, the worksheet 11 related client brand, client level and location as inputs, and obtain a priority indicator by searching a preset table. Specifically, a table storing priority indicators is preset based on the SLA. And then, the inherent attribute of the worksheet 11, the service type of the worksheet 11, the worksheet 11 related client brand, client level and location are taken as inputs to match with a corresponding record in the preset table and return a matched priority indicator.

Wherein, the inherent attribute part of the worksheet 11 may be preset, or can be set when updating the worksheet 11 during working process.

The SLA part (SLA compensation part): the SLA may include one or more articles, and the description of the calculation below will be made as taking only one article into account when calculating. When there are multiple SLA articles, the priority of each SLA article is calculated cyclically and is then summed up. The parameters in the SLA articles, which are related to the worksheet disposal, include a committed processing time and an amount of reimburse. If an elapsed time is no less than the committed processing time, that means a breach of the SLA, thus, a calculation formula for calculating the priority of the worksheet 11, especially, the SLA part is as follows.

SLA part priority=amount of reimburse×A

Wherein, “A” represents an proportion for the amount of reimburse, indicative of a ratio value of the priority derived from the SLA calculation to the priority calculated based on the inherent attribute part of the worksheet 11. The value of “A” may be set to 10 in the present embodiment.

If an elapsed time is less than the committed processing time, indicative of no breach of the SLA, thus, a calculation formula for the priority of the worksheet 11, SLA part is as follows.

SLA part priority=A×amount of reimburse×C×committed processing time/(B×(committed processing time−elapsed time)̂N+C×committed processing time)

Wherein, N is a calculation constant, indicative of a calculation of a remaining processing time. The value of N can be set to 2 in the present embodiment. B and C are calculation constants serving as balance coefficients for the formula. The value of B can be set to 1 and the value of C can be set to 5 in the present embodiment.

The aforementioned amount of reimburse indicates an amount of loss due to a breach of the SLA article. The committed processing time is a committed processing time for the worksheet 11 specified in the SLA article. The elapsed time is an accumulation value indicative of an accumulation of the elapsed time for the worksheet 11.

A calculation formula for the priority of time accumulation part for the worksheet 11 is as follows.

time accumulation part priority=D×elapsed time

Wherein, D represents a contribute ratio of the time accumulation part to the whole priority of worksheet 11, which is set to 0.3 herein. A calculation formula for the priority of the worksheet 11 is as follows.

priority=worksheet inherent attribute part priority+SLA part priority+time accumulation part priority.

Step S309: The validity period of the worksheet 11 is calculated. The validity period can be a fixed value, or can be a value related to at least one of the following parameters: service type, the client information, and the SLA information.

Step S310: The priority and the validity period of the worksheet 11 is updated.

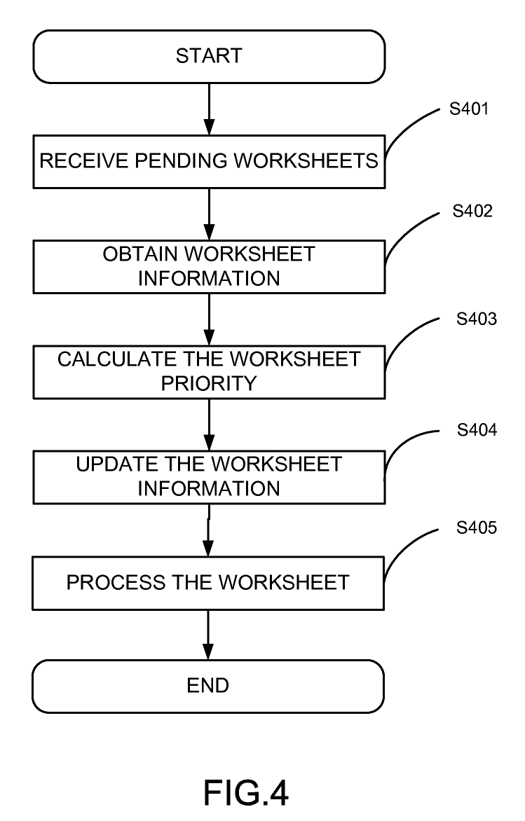

Also, referring to FIG. 4, a method for processing worksheet is further provided according to an embodiment of the present invention. The method includes steps as follows.

Step S401: Pending worksheets are received. The pending worksheets may be arranged in the sequence according to their priorities in the workflow engine 12, waiting for processing.

Step S402: Worksheet information is obtained. The worksheet information includes worksheet validity period information and client information.

Step S403: The worksheet priority is calculated based on the SLA. The present step is identical with step S308, which is omitted herein.

Step S404: The worksheet information is updated according to the worksheet priority. The worksheet priority information is updated according to the new worksheet priority.

Step S405: The worksheet is processed according to the worksheet priority sequence. The worksheet is processed according to a new priority sequence. The aforementioned step S401 to step S405 may be performed repeatedly. Step S402 to step S404 refer to a procedure for worksheet priority management, which can be replaced by the aforementioned step S301 to step S310.

The following description will be made with a specific application example.

An ordinary client X makes a complaint at 9 o'clock. Accordingly, the system receives a complaint worksheet X. A group client Y brings forward a consultation at 9:30. Accordingly, the system receives a consultation worksheet Y. A VIP client Z makes a complaint at 9:00. Accordingly, the system receives a complaint worksheet Z.

The worksheet priority managing system calculates the priority for worksheet X, worksheet Y and worksheet Z in the system, respectively. Formulas for the three worksheets are as follows, where “t” represents an elapsed time for the worksheet, with the unit of time being a minute.

Worksheet X: the worksheet inherent attribute part is calculated based on the client brand, client level, location and complaint. Here, by searching the preset table, the value of the priority as 2 is obtained.

The SLA part is calculated with a default SLA, since ordinary client X has not signed an SLA. The committed time for processing, such as a reply, is within 24 hours, and the amount of reimburse is 1.

The calculation formula for the priority of worksheet X is obtained according to the above information.

priority=2+(10*1*5*24*60/((24*60−t)̂2+5*24*60))+0.1*t=2+(72000/((1440−t)̂2+7200))+0.1*t

Worksheet Y: the worksheet inherent attribute part is calculated based on the client brand, client level, location and complaint. Here by searching the preset table, the value of the priority as 10 is obtained.

The SLA part is calculated with a SLA signed by the group client Y. The committed time for processing (such as a reply) is within 12 hours, and the amount of reimburse is 50.

The calculation formula for the priority of worksheet Y is obtained according to the above information.

priority=10+(10*50*5*12*60/((12*60−t)̂2+5*12*60))+0.1*t=10+(1800000/((720−t)̂2+3600))+0.1*t

Worksheet Z:

the worksheet inherent attribute part is calculated based on the client brand, client level, location and complaint, which is a priority of 5 obtained in the lookup table.

The SLA part is calculated with a SLA signed by the VIP client Z. The committed time for a reply is within 10 hours, and the amount of reimburse is 100.

The calculation formula for the priority of worksheet Z is obtained according to the above information.

priority=5+(10*100*5*10*60/((10*60−t)̂2+5*10*60))+0.1*t=5+(3000000/((600−t)̂2+3000)+0.1*t

At 8:59, the worksheet priority managing system searches for the workflow engine to look for a worksheet with a priority validity period being less than the current time. At this point, since no worksheet is returned, the system will be suspended until a next calculation time, which is set to be a suspension for one minute according to the present example.

At 9:00, the worksheet priority managing system searches for the workflow engine, and returns worksheet X which is allocated to the calculating subsystem for a calculation. The calculating subsystem finds out the client information on client X corresponding to the worksheet based on worksheet X. A SLA database is searched based on client X, but no SLA is found. A default SLA for such type of the client is obtained by a combination match based on the client level (ordinary client), client brand (GoTone) and location (Shen Zhen) of client X, and the service type (complaint) which is included in the worksheet information, to thereby search for the required SLA articles (committed time for a reply is within 24 hours, and amount of reimburse is 1) and return the agreement articles. A priority of 2.13465 is derived from the priority calculation formula, and the priority validity period is set to 5 minutes, i.e., the priority validity period is extended to 9:05. Thus, the information is written back to worksheet X data in the workflow engine.

At 9:01, the worksheet priority managing system searches for the workflow engine, and returns a result of null since the validity period of worksheet X is updated to 9:05. Therefore, the system is suspended unit a next calculation time. The step is repeated at 9:02, 9:03 and 9:04.

Until 9:05, the worksheet priority managing system finds out worksheet X, re-calculates the priority as 2.634891, and sets the priority validity period to 9:10. Thus, the priority and the validity period are written back to worksheet X data in the workflow engine.

According to the priority derived from the above cycle calculation at each time point, some priority data from the calculation are illustrated below. As illustrated in Table 1:

TABLE 1
table of the relationship between worksheet priority and time

| time | worksheet X | worksheet Y | worksheet Z |
|---|---|---|---|
| 9:00 | 2.034602 | | |
| 9:01 | 2.13465 | | |
| 9:02 | 2.234698 | | |
| 9:30 | 5.036085 | 13.44828 | 13.26446 |
| 10:00 | 8.037665 | 16.75235 | 17.14913 |
| 11:00 | 14.04115 | 23.49438 | 25.40251 |
| 12:00 | 20.04515 | 30.47945 | 34.59854 |
| 13:00 | 26.04975 | 37.82594 | 45.34236 |
| 14:00 | 32.0551 | 45.73362 | 58.80965 |
| 15:00 | 38.06135 | 54.56069 | 77.52569 |
| 16:00 | 44.06873 | 65 | 107.6943 |
| 17:00 | 50.07752 | 78.52941 | 167.6471 |
| 18:00 | 56.08811 | 98.73585 | 326.2703 |
| 19:00 | 62.10101 | 135.9655 | 831.2308 |
| 20:00 | 68.11696 | 226.8462 | 1062 |
| 21:00 | 74.13699 | 479 | 1068 |

It is noted from the table illustrated above that the priority relates to the SLA signed by client. In this example, the amount of reimburse for worksheet Z is 100, and the amount of reimburse for worksheet Y is 50, while there is no SLA for worksheet X. Therefore, at a same time, priority of worksheet Z>priority of worksheet Y>priority of worksheet X. Much attention is paid to a service request from a VIP client.

After a period of time, the priority of worksheet X made from the ordinary client X without signing an SLA is higher that the original priority of the worksheet made from the group client Y or the VIP client Z. For instance, the priority of worksheet X arrives at 62.10101 after ten hours, which is higher than the priority of worksheet Y after five hours and thirty minutes (i.e., 54.56069), and is also higher than the priority of worksheet Z after four hours and thirty minutes. Thus, it may ensure to process a service request from a client of a low priority, and ensure a fair system accordingly.

The worksheet processing subsystem 14 obtains the worksheet 11 in the workflow engine 12 via the pending worksheet obtaining subsystem 13 according to worksheet priorities. When an only consideration in such scenario is to obtain a worksheet with a highest priority for processing, an obtained worksheet will be worksheet X at 9:00, or an obtained worksheet will be worksheet Y at 9:30, or an obtained worksheet will be worksheet Z at 10:00.

According to the embodiments of the present invention, the priority of the worksheet 11 is calculated by the calculating unit 23 based on the SLA, so that the worksheet 11 with a low original priority may have an opportunity of obtaining a reallocated priority for not being processed after quite a long time. Thus, it may ensure that internal resources in an enterprise can be allocated based on an SLA. And meanwhile, it may not occur that the user with a low SLA is always given no opportunity of the service. As a result, priorities for worksheets are appropriately allocated. Furthermore, worksheet priorities are calculated by the calculating unit 23 and updated by the updating unit 24, to thereby prevent the man-made subjective and random performance of the administrator. System resources are saved with the delay conducted by the delaying unit 211, so that the system may process the priority of the worksheet 11 regularly. The validity period of the worksheet 11 is obtained by the validity period obtaining unit 213, and the validity period is determined by the determining unit 214, to thereby avoid the case of a reallocation for a valid worksheet. The client information is determined by the agreement determining unit 221, and an SLA match is performed by the agreement searching unit 223 based on the determination result by the agreement determining unit 221, so that the calculation for the priority of the worksheet 11 is more appropriate and is accordant with the fairness doctrine.

With the description of the foregoing embodiments, it is readily appreciated by those skilled in the art that the present invention may be implemented with software on a necessary hardware platform. Of course, the embodiment may also be implemented with hardware. But, most of the time, the former approach is more preferable. Based on this understanding, technical solutions of the present invention, or the part which the present invention makes contribution over the prior art may be embodied in a software product. The computer software product may be stored in a readable storage media. The software product may include a set of instructions enabling a computer (may be a personal computer, a server, or a network device, etc.) to perform methods according to various embodiments of the present invention.

In summary, the foregoing is merely preferred embodiments of the present invention and is not intended to be limiting to the scope of the present invention. Any modifications, equivalents, improvements made within the spirit and principle of the present invention shall be construed as fall within the scope of the present invention.

What is claimed is:

1. A method for managing worksheet priority, characterized in comprising steps of:
obtaining worksheet information;
calculating a worksheet priority based on a Service Level Agreement; and
updating the worksheet information based on the worksheet priority.

2. The method of claim 1, characterized in further comprising, prior to the step of obtaining worksheet information, a delaying step that the delaying is to provide a trigger signal after a fixed time.

3. The method of claim 1, characterized in that, the process of calculating a worksheet priority based on a Service Level Agreement comprises: a calculation of a priority based on a worksheet inherent attribute part, or a calculation of a priority based on a time accumulation part, or an addition calculation of a priority based on a Service Level Agreement part.

4. The method of claim 2, characterized in that, the process of calculating a worksheet priority based on a Service Level Agreement comprises: a calculation of a priority based on a worksheet inherent attribute part, or a calculation of a priority based on a time accumulation part, or an addition calculation of a priority based on a Service Level Agreement part.

5. The method of claim 3, characterized in that, an addition calculation formula based on the Service Level Agreement compensation part is:
priority of the Service Level Agreement part=amount of reimburse×A
wherein, A represents an addition proportion for the amount of reimburse.

6. The method of claim 1, characterized in further comprising:
calculating a validity period of the worksheet; and
updating information on the worksheet validity period based on the calculated result.

7. The method of claim 6, characterized in that, after worksheet information is obtained, the method further comprises:
determining whether the validity period of the worksheet is less than current time, and performing the step of calculating the worksheet priority based on the Service Level Agreement whether the validity period of the worksheet is less than current time.

8. The method of claim 1, characterized in further comprising: determining whether a client corresponding to the worksheet has signed the Service Level Agreement based on client information on the worksheet; and searching for corresponding articles if the client has signed the Service Level Agreement.

9. The method of claim 8, characterized in further comprising: taking default articles as Service Level Agreement articles if Service Level Agreement has not been signed.

10. The method of claim 1 characterized in that, the Service Level Agreement is stored in a storing unit in a system for managing worksheet priority.

11. The method of claim 1, characterized in that, the process of calculating a worksheet priority based on a Service Level Agreement comprises: a calculation of a priority based on a worksheet inherent attribute part, a calculation of a priority based on a time accumulation part, and an addition calculation of a priority based on a Service Level Agreement compensation part.

12. A system for managing worksheet priority, characterized in comprising: a worksheet information obtaining module, an agreement processing module, a calculating unit and an updating unit, wherein,
the worksheet information obtaining module is configured to obtain priority information and client information on the worksheet;
the agreement processing module is configured to provide a Service Level Agreement based on client information obtained by the worksheet information obtaining module;
the calculating unit is configured to calculate a priority of the worksheet based on the priority information obtained by the worksheet information obtaining module and the Service Level Agreement provided by the agreement processing module; and
the updating unit is configured to update the priority information on the worksheet based on the priority calculated by the calculating unit.

13. The system of claim 12, characterized in that, the worksheet information obtaining module further comprises: a delaying unit and an information reading unit, wherein,
the delaying unit is configured for timing, in order to generate a trigger signal after a fixed time;
the information reading unit is configured to read the priority information and the client information on the worksheet.

14. The system of claim 12, characterized in that, the worksheet information obtaining module further comprises: a time obtaining unit, a validity period obtaining unit and a validity period determining unit, wherein,
the time obtaining unit is configured to obtain current time based on the trigger signal provided by the delaying unit;
the validity period obtaining unit is configured to obtain a validity period of the worksheet; and
the validity determining unit is configured to determine whether the validity period of the worksheet obtained by the validity obtaining unit is less than the current time obtained by the time obtaining unit, and if the validity period of the worksheet is less than current time, the calculating unit is notified to calculate the worksheet priority based on the Service Level Agreement.

15. The system of claim 12, characterized in that, the agreement processing module further comprises: an agreement determining unit, a storing unit and an agreement searching unit, wherein,
the agreement determining unit is configured to determine whether a client corresponding to the worksheet has signed the Service Level Agreement based on the client information on the worksheet obtained by the worksheet information obtaining module;
the storing unit is configured to store the Service Level Agreement articles; and
the agreement searching unit is configured to search for the Service Level Agreement stored in the storing unit after it is determined by the agreement determining unit that the client corresponding to the worksheet has signed the Service Level Agreement.

16. A system for processing worksheet, characterized in comprising:
a worksheet priority management system, configured to manage a priority of the worksheet;
a workflow engine, configured to coordinate and schedule a turnover for the worksheet, and receive the worksheet, wherein the worksheet is arranged in a priority sequence in the workflow engine according to the worksheet priority management system;
a pending worksheet obtaining subsystem, configured to obtain a worksheet with a currently higher priority in the workflow engine; and
a worksheet processing system, configured to process the worksheet obtained by the pending worksheet obtaining subsystem based on the worksheet priority.

17. The system of claim 16, characterized in that, the worksheet priority management system comprises: a worksheet information obtaining module, an agreement processing module, a calculating unit and an updating unit, wherein,
the worksheet information obtaining module is configured to obtain priority information and client information on the worksheet;
the agreement processing module is configured to provide a Service Level Agreement based on client information obtained by the worksheet information obtaining module;
the calculating unit is configured to calculate a priority of the worksheet based on the priority information obtained by the worksheet information obtaining module and the Service Level Agreement provided by the agreement processing module; and
the updating unit is configured to update the priority information on the worksheet based on the priority calculated by the calculating unit.
